(19) United States
(12) Patent Application Publication
(10) Pub. No.: US 2025/0066934 A1
(43) Pub. Date: Feb. 27, 2025

(54) Methods of Operating a Water Electrolyzer

(71) Applicant: ALCHEMR, INC., Boca Raton, FL (US)

(72) Inventors: Vesna Stanic, West Palm Beach, FL (US); Rich Masel, Boca Raton, FL (US)

(21) Appl. No.: 18/453,176

(22) Filed: Aug. 21, 2023

(51) Int. Cl. C25B 11/054; C25B 11/075

(52) U.S. Cl. CPC C25B 11/054; C25B 11/075

(57) ABSTRACT

A method of running a water electrolyzer that can operate on seawater without a significant voltage rise. In some embodiments, the method includes the use of specific ionomers in the catalyst layer. In some embodiments, the method involves using a Break-In Procedure. In some embodiments, the method can include periodic interruption of the voltage to the AEM electrolyzer.

### STATEMENT OF GOVERNMENT INTEREST

This invention was made, at least in part, with support from the U.S. Department of Energy under DE-SC0020712. The government has certain rights in the invention.

### FIELD OF THE INVENTION

The field of the invention is electrochemistry. The devices, systems, and methods described involve the electrolysis of water to produce hydrogen.

### BACKGROUND OF THE INVENTION

The production of hydrogen via the electrolysis of water is a growing field. Most water electrolyzers need highly purified water to run. As such, these systems require expensive water purification systems to operate efficiently.

Over the years there have been many attempts to operate electrolyzers on impure streams such as sea water, but the results were limited because side reactions reduced efficiency. For example, most electrolyzers using sea water as a feed produce chlorine or chlorate as a byproduct. Chlorine is both dangerous and corrosive.

Some publications, such as GONG et al., “An Advanced Ni—Fe Layered Double Hydroxide Electrocatalyst for Water Oxidation”, Journal of the American Chemical Society 135 (2013), pp 8452-8455 have shown Ni—Fe Layered Double Hydroxide (NiFe-LDH) catalysts to be active for oxygen evolution under alkaline conditions.

In DRESP et al., “Efficient Direct Seawater Electrolysers Using Selective Alkaline NiFe-LDH as OER Catalyst in Asymmetric Electrolyte Feeds”, Energy & Environmental Science 13 (2020), pp 1725-1729 the Ni—Fe Layered Double Hydroxide catalyst of GONG was tested for sea water electrolysis in an AEM electrolyzer. It was found that the catalysts were active for oxygen evolution in sea water and suppressed the side reaction of chlorine and chlorate formation. Related findings are disclosed in U.S. Pat. Nos. 11,362,340 and 11,326,265. Nevertheless, the U.S. Pat. Nos. 11,362,340 and 11,326,265 patents did not disclose tests involving long-term use of the GONG catalyst in electrolyzers.

However, ZING et al., “Long-Term Durability Test of Highly Efficient Membrane Electrode Assemblies for Anion Exchange Membrane Seawater Electrolyzers”, Journal of Power Sources 558 (2023) 232564 “ZING” discussed running an AEM water electrolyzer with an NiFe-LDH catalyst for over 1000 hours on sea water. The device in ZING utilized a Dioxide Materials® 5 cm² water electrolyzer cell with a Dioxide Materials® Sustainion® X-37 membrane. The anode was NiFe-LDH on a platinized titanium fiber felt (Fuel Cell Store) with a Nafion® binder. The cathode was a Raney® nickel catalyst (Sigma-Aldrich) on nickel fiber felt with a Nafion® binder. ZING demonstrated that the cell could operate on sea water for over 1000 hours. However, ZING found that the electrolyzer performance was limited. In particular, the cell voltage needed to maintain a constant current increased by between 400 and 600 microvolts/hr. This is too fast of a voltage rise to be practical in real-world applications.

### SUMMARY OF THE INVENTION

Water electrolyzers with modified catalyst layers, and methods of operating electrolyzers to produce more stable performance when operating with sea water are disclosed.

In some preferred embodiments, the catalyst layer comprises nickel with a hydrocarbon based ionomer.

In some preferred embodiments, the anode catalyst layer comprises NiFe-LDH with a hydrocarbon based ionomer.

In some preferred embodiments, the hydrocarbon ionomer comprises no more than 1% fluorine by weight. In some more preferred embodiments, the hydrocarbon ionomer is essentially fluorine free.

In some preferred embodiments, the hydrocarbon based ionomer is a copolymer produced by the reaction of styrene and vinylbenzyl-Rs, where Rs is an amine.

In some preferred embodiments, vinylbenzyl-Rs comprises the reaction product of a benzyl-X, wherein X is a halogen, with at least one of: 1,2,2,6,6-pentamethylpiperidine, 1,2,2,5,5-pentamethylpyrrolidine, tetramethylimidazole, triethylamine, tripropylamine, trimethylamine, N-methylpiperdine, 1-ethylpiperidine, piperidine, 1,4′-bipiperidine, 1-methylpyrrolidine, 2,2,6,6-tetramethylpiperidine, pyrrolidine, 1-pyrrolidine ethanamine, 2,3,5-trimethylpyridine, 2,4,6-trimethylpyridine, 2,6-dimethylpyridine, 2,4-dimethylpyridine, 2,3,5-trimethylpyridine, 4-methyl-2-(1-pyrrolyl)pyridine, 2-methylpyridine, 3-methylpyridine, 4-methylpyridine, pyridine, 4,4′-dipyridyl, 2,2′-bipyridyl, tributylamine, N,N-diisopropylethylamine, triphenylamine, N,N-dimethylcyclohexylamine, N,N-dicyclohexylmethylamine, triphenylphosphine, 1,2-dimethylindole, indole, 1-methylindole, hexamethylenetetramine, 2,3,5,6-tetramethylpyrazine, 2,3,5-trimethylpyrazine, 2,3-dimethylpyrazine, 3-methylpyridazine, 2-methylpyrazine, 2,3-diethylpyrazine, ethylpyrazine, pyrazine, 1-methylimidazole, pyrimidine, 4-methylpyrimidine, pyridazine, triazole, 3,5-dimethyl-1,2,4-triazole, 1,2-dimethylimidazole, 2,4,5-triphenylimidazole, 1-decyl-2-methylimidazole, 1-(2-hydroxyethyl) imidazole, guanidine, tetramethyl guanidine, dipiperidine, dipyridine, ethylenediamine, propylenediamine, N,N,N′-trimethylethylenediamine, ethylenediaminetetraacetic acid, alkyldiamines, other diamines, ethanolamine, triethanolamine, methylethanolamine, dimethylethanolamine, propanolamine, 3-butenylmagnesium, isobutylmagnesium bromide, cyclohexylmagnesium chloride, and amino acid.

In some preferred embodiments, vinylbenzyl-Rs comprises the reaction product of tetramethylimidazole and a benzyl-X, wherein X is a halogen.

In some preferred embodiments, an electrolyzer is operated as described below. First, upon starting the electrolyzer, a Break-In Procedure is used. Next the applied voltage is periodically interrupted.

In some preferred embodiments, the Break-In Procedure comprises one or more of the following steps:

(A) First the electrolyzer is run with no current applied for a given amount of time. In some embodiments, the given amount of time is at least one hour. In some preferred embodiments, the given amount of time is at least eight hours. In some more preferred embodiments, the given amount of time is at least sixteen hours. In some even more preferred embodiments, the given amount of time is at least twenty-four hours.

(B) Next, current is applied to the cell in n increments, wherein each increment raises the current by the Steady State Current divided by (n+1). In some embodiments, n equals at least 3. In some preferred embodiments, n is at least 5 and no more than 10.

(C) Next, the current is held for a given amount of time. In some embodiments, the given amount of time is at least one hour. In some preferred embodiments, the given amount of time is at least eight hours. In some more preferred embodiments, the given amount of time is at least sixteen hours. In some even more preferred embodiments, the given amount of time is at least twenty-four hours.

(D) The current is then fixed at the Steady State Current.

### DETAILED DESCRIPTION OF ILLUSTRATIVE EMBODIMENTS

It is understood that the process is not limited to the particular methodology, protocols and reagents described herein, as these can vary as persons familiar with the technology involved here will recognize. It is also to be understood that the terminology used herein is used for the purpose of describing particular embodiments only, and is not intended to limit the scope of the process. It also is to be noted that as used herein and in the appended claims, the singular forms “a,” “an,” and “the” include the plural reference unless the context clearly dictates otherwise. Thus, for example, a reference to “a linker” is a reference to one or more linkers and equivalents thereof known to those skilled in the art. Similarly, the phrase “and/or” is used to indicate one or both stated cases can occur, for example, A and/or B includes (A and B) and (A or B).

Unless defined otherwise, technical and scientific terms used herein have the same meanings as commonly understood by one of ordinary skill in the art to which the process pertains. The embodiments of the process and the various features and advantageous details thereof are explained more fully with reference to the non-limiting embodiments and/or detailed in the following description. It should be noted that features of one embodiment can be employed with other embodiments as the skilled artisan would recognize, even if not explicitly stated herein.

Any numerical value ranges recited herein include all values from the lower value to the upper value in increments of one unit, provided that there is a separation of at least two units between any lower value and any higher value. As an example, if it is stated that the concentration of a component or value of a process variable such as, for example, size, angle size, pressure, time and the like, is, for example, from 1 to 98, specifically from 20 to 80, more specifically from 30 to 70, it is intended that values such as 15 to 85, 22 to 68, 43 to 51, 30 to 32, and the like, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

Moreover, provided immediately below is a “Definitions” section, where certain terms related to the process are defined specifically. Particular methods, devices, and materials are described, although methods and materials similar or equivalent to those described herein can be used in the practice or testing of the process.

### Definitions

The term “polymer electrolyte membrane” as used here refers to both cation exchange membranes, which generally comprise polymers having multiple covalently attached negatively charged groups, and anion exchange membranes, which generally comprise polymers having multiple covalently attached positively charged groups. Typical cation exchange membranes include proton conducting membranes, such as the perfluorosulfonic acid polymer available under the trade designation NAFION® from E. I. du Pont de Nemours and Company (DuPont) of Wilmington, DE.

The term “anion exchange membrane electrolyzer” or “AEM electrolyzer” as used here refers to an electrolyzer with an anion-conducting polymer electrolyte membrane separating the anode from the cathode.

The term “PEM electrolyzer” as used here refers to an electrolyzer with a proton-conducting polymer electrolyte membrane separating the anode from the cathode.

The term “TMIM” as used here refers to tetramethyl-imidazolium cations.

The term “MEA” as used here refers to a membrane electrode assembly.

The term “Millipore water” as used here is water that is produced by a Millipore® filtration system with a resistivity of at least 18.2 megaohm-cm.

The term “Steady State Current” as used here refers to the current applied to the electrolyzer after an initial startup.

The term “Break-In Procedure” as used herein refers to a procedure for conditioning an electrolyzer to improve its performance. The Break-In Procedure involves initially running the electrolyzer at a lower current than the Steady State Current.

### Specific Example

The following experiments were done using the same equipment as in ZING except that the catalyst layers did not contain Nafion®. Instead, an ionomer comprising a copolymer of styrene and vinylbenzyl-Rs, where vinylbenzyl-Rs comprises the reaction product of tetramethylimidazole and a benzyl-X, wherein X is a halogen was used. The ionomer is sold under the trade name Sustainion® XA-9 by Dioxide Materials.

The experiments used a Dioxide Materials® 5 cm² water electrolyzer cell with a Sustainion® X-37 membrane. The anode was NiFe-LDH on a platinized titanium fiber felt (Fuel cell store) with a Sustainion® XA-9 ionomer. The cathode was a Raney® nickel catalyst (Sigma-Aldrich) on nickel fiber felt with a Sustainion® XA-9 ionomer.

First, 1 M KOH was fed into the anode and cathode of the cell. Several Break-In Procedures were tried, including those discussed in BENDER et al., “Initial Approaches in Benchmarking and Round Robin Testing for Proton Exchange Membrane Water Electrolyzers”, International Journal of Hydrogen Energy 44 (2019), pp 9174-9187 “BENDER” and ALIA et al., “Electrolyzer Durability at Low Catalyst Loading and with Dynamic Operation”, Journal of The Electrochemical Society 166 (2019), pp F1164-F1172 “ALIA”.

It was found that the following Break-In Procedure (Break-In Procedure A) produced more stable long-term performance when compared to the procedures of BENDER and ALIA. This is due in part to the fact that the procedures in BENDER and ALIA utilized iridium-based catalysts (compared to the NiFe-LDH catalyst of Break-In Procedure A). Iridium-based catalysts require lower voltages. The disclosed voltages of BENDER and ALIA are out of the range useful for seawater electrolyzers. In addition, the procedures in BENDER and ALIA used voltage control after the initial startup instead of continuing to follow a Break-In Procedure, such as Break-In Procedure A.

Break-In Procedure A included the following steps: (A) the electrolyzer was run for 24 hours with no current or voltage applied; (B) 1/6 of the Steady State Current was applied and held for twenty-four hours; (C) 2/6 of the Steady State Current was applied and held for twenty-four hours; (D) 3/6 of the Steady State Current was applied and held for twenty-four hours; (E) 4/6 of the Steady State Current was applied and held for twenty-four hours; (F) 5/6 of the Steady State Current was applied and held for twenty-four hours; and (G) the Steady State Current was applied and held.

Break-In Procedure A differs from the Break-in-Procedures in BENDER and ALIA in several ways including, but not limited to, the fact that the current is controlled throughout Break-In Procedure A instead of switching to voltage control later in the Break-In Procedure like done in BENDER and ALIA. In addition, six intermediate currents are used in Break-In Procedure A, while BENDER and ALIA only included one intermediate current. Additionally, the intermediate current is held for 24 hours in Break-In Procedure A compared to 30 minutes in BENDER and 1 hour in ALIA.

Break-In Procedure A can be generalized by the following four steps:

(A) An electrolyzer is run with no current applied for at least one hour. In some preferred embodiments, no current is applied for at least eight hours. In some more preferred embodiments, no current is applied for at least sixteen hours. In some most preferred embodiments, no current is applied for at least twenty-four hours.

(B) A current is then applied to the cell in n increments, wherein each increment raises the current by a Steady State Current divided by (n+1) wherein n is at least 3. In some preferred embodiments, n is at least 5 and no more than 10.

(C) The current is held for at least one hour. In some preferred embodiments, the current is held for at least eight hours. In some more preferred embodiments, the current is held for at least sixteen hours. In some most preferred embodiments, the current is held for at least twenty-four hours.

(D) The current is fixed at the Steady State Current.

It was found that, at least in some embodiments, periodic interruption of the voltage to the AEM electrolyzer increased the long-term performance. This contrasts with the results published in Weiβ et al., “Impact of Intermittent Operation on Lifetime and Performance of a PEM Water Electrolyzer”, Jounel of the Electrochemical Society 166 (2019) pp F487-F497 which found that periodic interruption of a PEM electrolyzer leads to rapid degradation.

In some embodiments, the current can be held at the Steady State Current for at least five hours and then the power supply can be interrupted for less than one second.

Some embodiments of periodic interruption procedures can be generalized by the following two steps:

(A) The current is held steady at a Steady State Current for at least one hour. In some embodiments, the current is held steady at a Steady State Current for at least four hours.

(B) The current is interrupted for at most sixty seconds. In some preferred embodiments, the current is interrupted for at most ten seconds. In some more preferred embodiments, the current is interrupted for at most five seconds. In some more preferred embodiments, the current is interrupted for at most one second.

The disclosures of all references and publications cited above are expressly incorporated by reference in their entireties to the same extent as if each were incorporated by reference individually.

While particular elements, embodiments and applications of the present invention have been shown and described, it will be understood that the invention is not limited thereto since modifications can be made by those skilled in the art without departing from the scope of the present disclosure, particularly in light of the foregoing teachings.

The examples given above are merely illustrative and are not meant to be an exhaustive list of all possible embodiments, applications or modifications of the present electrochemical device. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the chemical arts or in the relevant fields are intended to be within the scope of the appended claims.

1. A method of operating an AEM water electrolyzer comprising a Break-In Procedure, wherein said Break-In Procedure comprises:
running said AEM water electrolyzer with no current applied for at least eight hours;
applying a current to a cell in n increments, wherein each increment raises said current by a Steady State Current divided by (n+1), wherein n equals at least 3;
holding said current for least at least eight hours at each increment; and
fixing the current at said Steady State Current.

2. The method of claim 1 wherein n equals at least 5 and no more than 10.

3. The method of claim 1 wherein said AEM water electrolyzer is run with no current applied for at least twenty-four hours.

4. The method of claim 1 wherein the current is held for at least twenty-four hours.

5. The method in claim 1 further comprising a periodic interruption, wherein said current is held at said Steady State current for at least one hour; and said current to said cell is interrupted for less than five seconds.

6. The method of claim 5 wherein said current is interrupted for no more than one second.

7. The method of claim 1 wherein said AEM water electrolyzer comprises a reaction product of tetramethylimidazole and a benzyl-X, wherein X is a halogen.

8. The method of claim 1 wherein said AEM water electrolyzer comprises a catalyst layer wherein said catalyst layer comprises nickel with a hydrocarbon based ionomer.

9. The method of claim 1 wherein said AEM water electrolyzer comprises an anode catalyst layer wherein said anode catalyst layer comprises NiFe-LDH with a hydrocarbon based ionomer.

10. The method of claim 9 wherein said hydrocarbon based ionomer includes no more than 1% fluorine by weight.

11. The method of claim 9 wherein said hydrocarbon based ionomer is fluorine free.

12. The method of claim 9 wherein said hydrocarbon based ionomer is a copolymer produced by the reaction of styrene and vinylbenzyl-Rs, wherein Rs is an amine.

13. The method of claim 12 wherein vinylbenzyl-Rs comprises a reaction product of tetramethylimidazole and a benzyl-X, wherein X is a halogen.

14. The method of claim 6 wherein said AEM water electrolyzer comprises an anode catalyst layer wherein said anode catalyst layer comprises NiFe-LDH with a hydrocarbon based ionomer;
wherein said hydrocarbon based ionomer is a copolymer produced by the reaction of styrene and vinylbenzyl-Rs,
wherein Rs is an amine; and
wherein vinylbenzyl-R, comprises a reaction product of tetramethylimidazole and a benzyl-X, wherein X is a halogen.
